(19) United States
(12) Patent Application Publication
(10) Pub. No.: US 2022/0250763 A1
(43) Pub. Date: Aug. 11, 2022

(54) Charging Wing System for Aircraft

(71) Applicant: Elijah Abron, Silver Spring, MD (US)

(72) Inventor: Elijah Abron, Silver Spring, MD (US)

(21) Appl. No.: 17/714,573

(22) Filed: Apr. 6, 2022

(51) Int. Cl. B64D 41/00; F03D 9/32; F03D 3/04; F03D 9/25

(52) U.S. Cl. CPC B64D 41/00; F03D 9/32; F05B 2220/50; F03D 9/25; B64D 2221/00; F03D 3/0409

(57) ABSTRACT

A kinetic energy charging wing system comprising of: an energy recovery system for capturing kinetic air energy that is passing over the surface of an aircraft wing or the surface of a drone aircraft or other transport; the passing air is causing the swirl cage wheel blades shaft to rotate and also turning an alternator or a generator unit driveshaft; this kinetic energy system which transfers kinetic energy from air into mechanical energy from air passing over the surface of the aircraft and the atmosphere are being captured by swirl cage wheel blades; the system incorporates at least one swirl cage wheel unit and one alternator or generator unit that connected to a swirl cage wheel unit with a housing for the swirl cage wheel blades. This process supports the aircraft electrical system of aircraft of today and tomorrow, the system is coupled to the aircraft speed control module with a function for starting and stopping the charging system, the alternator or alternators that install within the body of an aircraft wing and run-on air pressure to start the rotating the swirl cage wheel blades also turning the charging unit to start creating electrical from the kinetic air energy, this electrical power joins to the aircraft's electrical system, and this converted electrical energy is in the Lithium-ion batteries storage bank process provides electrical energy that created from kinetic air energy that passes over an aircraft's surface and stores this electrical potential energy.

### BACKGROUND OF THE INVENTION

### Field of the Invention

This invention generally relates to the field of an electric charging system for an aircraft and more specifically, to a method of using wasted air kinetic energy and creating electrical power from this unused kinetic air with a swirl cage wheel/alternator unit to transform kinetically wasted air energy into mechanical energy to produce electricity that's coupled with a batteries storage bank within an aircraft.

### DESCRIPTION OF THE RELATED ART

The main downfalls of present electric aircraft are the charging time and process time of the systems aren't capable of readily recharging an electrical plane in a short period, the process may take hours to fully restored. Lithium-ion batteries take up a lot of space on an aircraft, and they are heavy.

The prime mission of an electric aircraft with a wing Alternator charging unit is for sustaining a longer flight time in the air, and extending the life of the aircraft batteries, the the aircraft propeller motor is another benefit for adding energy to the aircraft's electrical system; the charging swirl cage wheel blades start rotating faster as it produces more electrical power for the aircraft.

An electrical aircraft with this type of charging system and supporting systems also represent significant in saving and cost impact to aircraft operators in terms of the price of recharging cost for an electric aircraft with electric propeller motors the Lithium-ion batteries is the only fuel source for this type of aircraft the turnaround charging time of an electric drone? like aircraft without the wing, the charging process is hours of charging time, the recharging costs and time associated with that type of recharging system are costly to the owner of the aircraft.

The driveshaft regenerative braking unit results in fewer maintenance costs and fewer expenses to the operators. Furthermore, the regenerative braking driveshaft allowed an additional source of electric kinetic energy that is applied to the system to help ensure a fully charged batteries bank.

The charging system is also capable of dissipating the kinetic energy from the current regenerative braking unit on the driveshaft that has enough stopping and slowing down energy forces for the system as needed the slowing down of the swirl cage wheel driveshaft to keep the design from overrunning and overcharging of excess current to the aircraft bus electrical strategy from the wing alternators.

The systems are required to be designed to supply fully of its charging capability required to recharge the Lithium-ion batteries and provide electric energy to the aircraft's electrical the system, the plane with a wing alternator and regenerative braking unit on the driveshaft, is designed to meet the safety needs of an electrical aircraft with Lithium-ion batteries or use lead acids batteries to use for power. It is therefore desirable to convert a plane to a kinetic air a system using wind power to charge their aircraft and store this kinetic energy, this kinetic air energy recovered can help power the plane and its electrical components.

### SUMMARY OF THE INVENTION

The present invention provides kinetic energy that is converted and transferred into the batteries bank for redistribution into the system for use within the aircraft, the wing charging unit is supplying at least two branches of a plane; the system is charging Lithium-ion batteries and providing longer flight time by using the swirl cage wheel/Alternator the design, the system is capable of capturing in two modes regeneration mode and the swirl cage wheel/In Alternator mode, both charging systems are for supplying power to the batteries within the aircraft; the unit is mounted within the wing of the plane and the regeneration braking unit is mounded Besides the alternator unit, they are within the branches of the aircraft on both sides of the aircraft, the system operates by rotation from the air pressure passing over the wing surface at a high rate of speed, hitting the swirl cage wheel blades to create a process that makes the electricity from the kinetic air, the regeneration braking mode is when the alternator shaft rotates at a speed that is too high for the charging system, the braking unit starts to apply the brakes on the regeneration braking unit to start creating regeneration energy in the process.

In one embodiment, the system employs kinetic air energy Lithium-ion batteries storage system acting as the load to store charged electrical kinetic air energy created by the swirl cage wheel/alternator charging unit and the regeneration braking unit, the alternator is creating changing kinetic air into fuel for the Lithium-ion batteries storage system for operating power to the associated aircraft with wing alternator swirl cage wheel.

The kinetic air energy recovery Lithium-ion batteries storage and Lithium-ion batteries redistribution system also allows utilization of other electrical components needs within the aircraft needs. This system also employs a voltage regulator system which automatically activates the regenerative braking unit to help maintain the voltage output to the aircraft from the wing alternator.

The system is activated by either a set point of the RPM meter hall effect sensor, which is triggered when the RPM meter set point once met, which activates the regenerative braking driveshaft unit when a predetermined set point, the thermal sensor on the housing of a regenerative braking unit is a control unit; its thermal protection unit keeps the braking unit from overheating.

### BRIEF DESCRIPTION OF THE DRAWINGS

Each of the additional features and methods disclosed herein may be utilized separately or in conjunction with other features and techniques to provide improved embodiments of this invention and methods for making the same.

These and other features and advantages of the present invention will be better understood by reference to the following detailed description when considered in connection with the accompanying drawings wherein:

FIG. 1 Referring particularly to is a regenerative braking system with a gearbox;

FIG. 2 is a cross-section elevation view of an exemplary example view of a Hybrid wing alternator layout employing a charging system according to the present invention;

FIG. 3 is a cross-section elevation view of an exemplary non-gasoline wing alternator layout with batteries employing with the charging system according to the present invention;

FIG. 4 is a sectional top view looking down on the charging unit and the induction regeneration braking unit employed to transfer electrical energy to the onboard batteries bank;

FIG. 5 is a sectional side view of the two charging units; one is an Alternator, and the other is an Alternator that is turning to create the electrical energy from the kinetic air energy;

FIG. 6 is a sectional view of an aircraft wing side view showing the Kinetic air energy flow to transfer into electrical power;

FIG. 7 is a sectional view of alternator units with swirl cage wheels blades and housing;

FIG. 8 is a sectional layout view of the basic process of creating electrical energy from kinetic air energy;

FIG. 9 is a representative pictorial view of an aircraft with a wing alternator employing an embodiment of the present invention

FIG. 10 is a representative pictorial view of an aircraft with a wing alternator employing an embodiment of the present invention

FIG. 11 is a pictorial view of a swirl cage wheel and blades with blocking on the inner side of the wheel of the present invention

### DETAILED DESCRIPTION OF THE INVENTION

composite assembly of this invention is depicted generally at 70 and includes a propeller motor 707, a regenerative braking unit 90, and an aircraft wing 10, The heat sensor to stop overheating 95, an inverter 25, a voltage regulator, a propeller motor 707 controller 19, swirl cage wheel blades 23, speed control module 85, batteries 45, driveshaft 16, aircraft wing on the aircraft 77, generator 47, alternator 48, charging unit 55, air exit 100 vent, hall effect sensor 80, adjustment screw 747, stepper motor 75, air intake 717. Sensor 1000 for reading the rpm of the driveshaft, a conventional regenerative braking unit system 40 is mounted inline on the driveshaft 16 in tandem with the stepper motors and bearing blocks 76 on the driveshaft 16 that is designed to raise and lower the drivetrain with multi-units or single charging units, the drivetrain with stepper motors 75 (not shown) and screws unit 74 are to raise and lower the swirl cage wheel 23 units up to capture more of the incoming air to increase the speed of the unit and down to decrease the unit's RPM (Revolutions Per Minute), the swirl rage wheel 23 alternator and the conventional elements of the charging system. The thermal overload sensor 70 is used to thermally protect the dynamic braking 90 system from the high temperatures created by the regenerative braking unit on the driveshaft 16.

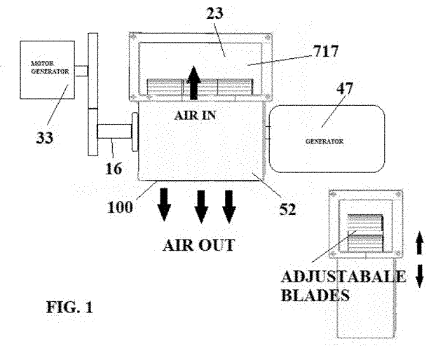

FIG. 1 is a referring particularly to a regenerative braking system that is connected to a gearbox; the drawing of a small and large swirl cage wheel unit. The larger unit has a gearbox and motor that attached to it, the motor acts as a secondary generator in mode 1 and in mode 2 it's a braking unit to slow down the driveshaft speed, when the motor speed is too high the Regenerative braking and energy recovery mechanism applies power the motor to start slow slows

down the swirl cage wheel speed by converting its kinetic energy into a form that used immediately to slow down or stop the drive shaft from moving. The secondary generator motor act as regenerative braking, which is used as the dynamic braking system to slow down the speed of the driveshaft. Once active, the motor-generator receives power from a controller to start applying a voltage to the motor that will run in the opposite direction of the swirl cage wheel system. So, this force from the motor that's pushing the driveshaft in the opposite is causing the system speed to decrease, the voltage output from the battery that powers the revising motor controller, this system that is attached to the driveshaft and when the system runs, it's a generator that is feeding power into the electrical system of the aircraft.

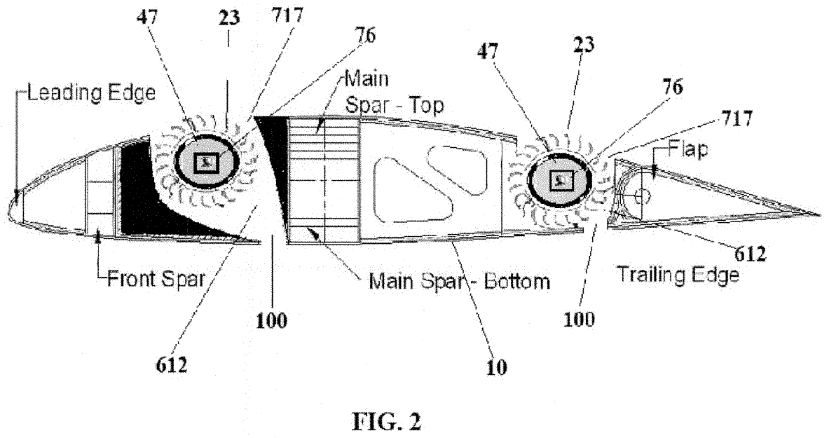

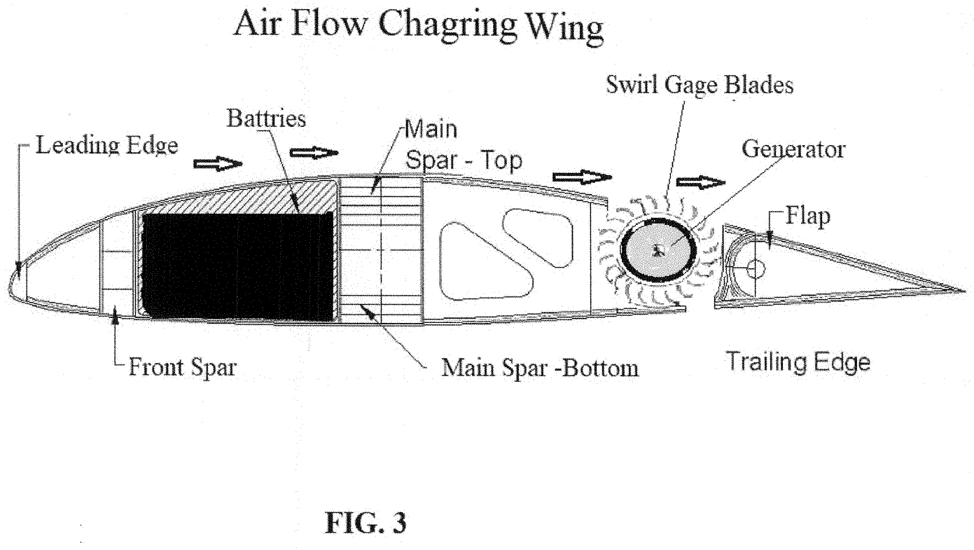

FIGS. 2 and 3, A system provided by embodiments of the present the invention in pictorial form FIG. 2. In this figure shows a side view of the swirl cage wheel blades unit 23, inside an aircraft wing, with the swirl cage wheel unit in this particular drawing an A.C. (Alternating current) 48 alternators mounted near the end of the aircraft wing, the system driveshaft and a D.C. (Direct Current) 47 generators are on each end of the driveshaft (Not shown) , while both units are on the same standard shaft along with the swirl cage wheel blades unit, the middle of the two units generator and alternator there is a screw 747 adjustment screw for adjusting the height of the swirl cage wheel blades with the block 76 mounting that's is driven by a stepper motor 75 unit that drives the swirl cage wheel unit up and down. the unit goes upward it catches more kinetic air making the swirl cage wheel turn faster and has more torque energy to produce electrical current from the kinetic air energy; the battery banks become fully charged. the stepper motor 75 unit moves the charging assembles downward when the system needs to produce a less electric current; in the drawing, 77 is the top the surface of the aircraft wing.

Referring particularly to FIGS. 3, this drawing is the same as in FIG. 2, a composite assembly of this invention is showing a battery storage area; in this location of the aircraft fuel tank location, it an aircraft has a conversion, this area can be a great storage area for the lithium-ion batteries; this section of the plane that's using gasoline fuel this section will be empty if the aircraft when thought a conversion process to convert to electric, replacing the fuel tank with a battery storage bank, also the charging unit can install in this area as well on the the front side of the wing also it's an excellent location for the charging unit as well because the air pressure is a lot higher in this location.

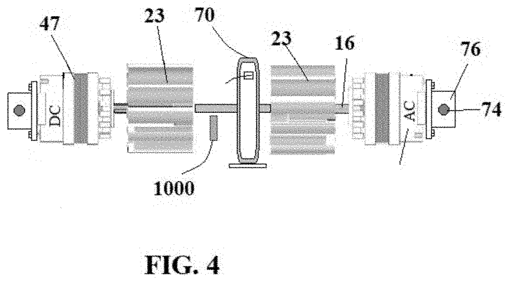

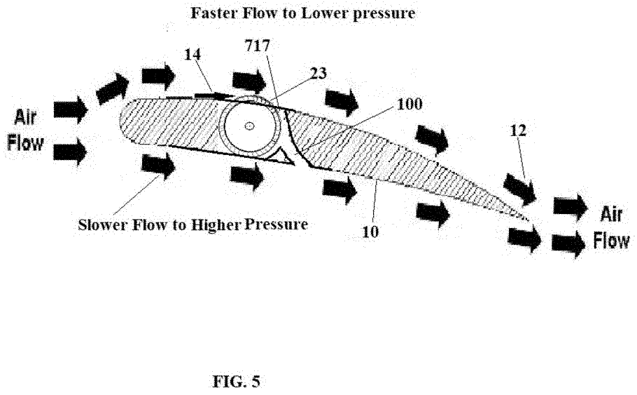

FIG. 5 As shown, the illustration in FIG. 4 shows an air 14 flows faster to lower air pressure on the top surface of an aircraft wing and flows slower to a higher pressure, as shown in the drawing illustration of air pressure over the top surface of the wing and below the wing 10 and lower or slower air pressure, the swirl cage wheel blades 23 capture the air and send it through an exhaust housing 52 within the wing 10 of the aircraft and exit 100 to the atmosphere. An also an air scoop 125 that is (Not shown) added to the leading edge of the plane in front of the swirl cage wheel blades that raise and lower to adjust the amount of air that's flowing into the charging swirl cage wheel fin section to capture more atmosphere if a larger generator unit is needed.

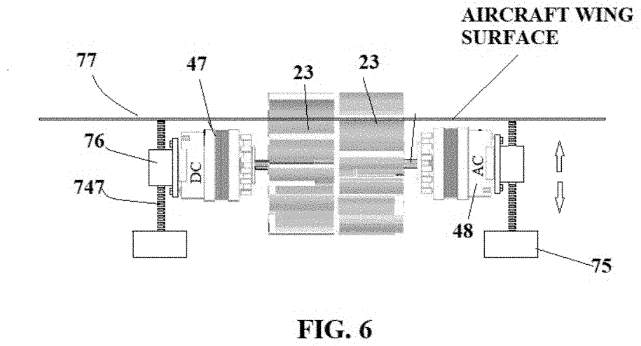

FIG. 6 This side view of the drivetrain with stepper motors 75 and screws unit 747 are designed to raise and lower the swirl cage wheel 23 units up above the surface of the wing of the aircraft 77 surface to capture more of the incoming kinetic air energy to increase the speed of the unit and down to decrease the unit's RPM (Revolutions Per Minute). the swirl cage wheel 23/Alternator and the conventional elements a the charging system. The stepper motor control unit also controls swirl cage wheel blades 23 when the aircraft is at the airport; as the plane sits the The charging level sensor monitors the battery management system by releasing the driveshaft on the unit and allowing the swirl cage wheel to turn and start recharging the battery as long as the wind is blowing on the aircraft, the thermal overload sensor (not shown) 70 is used to thermally protect the dynamic braking 90 system from the high temperatures created by the regenerative braking unit on the driveshaft 16.

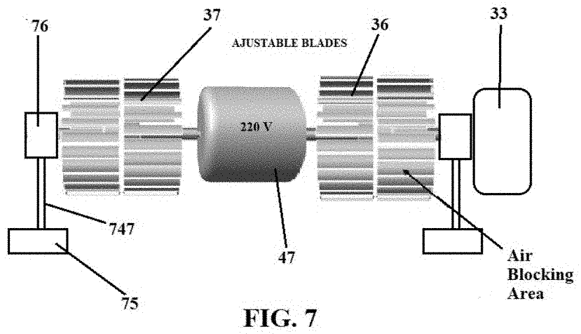

FIG. 7 Drawing showing a generator unit 47 with an output of 120/220 AC volts using dual swirl cage wheels with adjustable blades 37 and 36 on the right of the generator on both ends of the drive the shaft has mounting bearing blocks 76 on both ends of the driveshaft also has the same speed control as on FIG. 6 the stepper motor 75 and the adjustment screws 747 and the bearing block 76 a dynamic, regenerative braking unit that helps control the speed of the generator unit to keep it within the limits of 3600 RPM to produce 120 volts or 240 volts A.C. this voltage can be used in an aircraft for an item that requires a higher voltage like a heater, for example, this unit can be mounted anywhere on the plane, the swirl cage wheel section blades 23 has a blocking shield 612 mounted behind the fin inner section of the swirl cage wheel body to create a stronger airflow output.

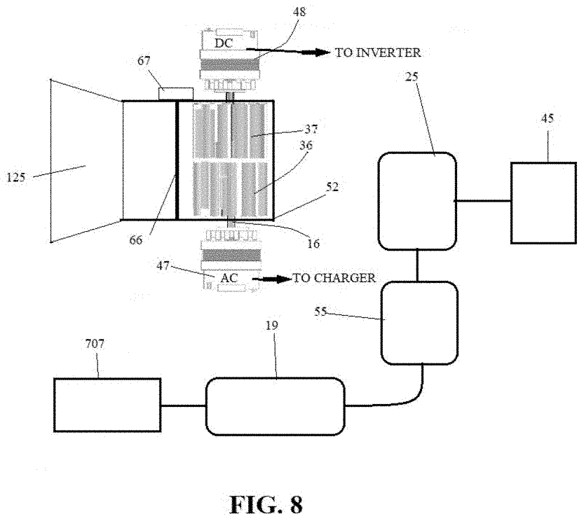

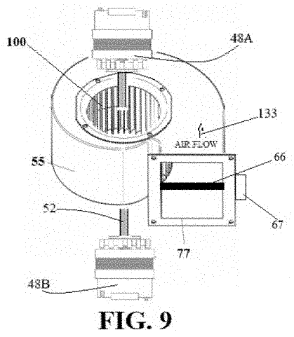

FIG. 8 and FIG. 9 show an alternator 47 and 48. The battery charging system can often utilize many sources of output power, levels of direct current (D.C.) provided by the alternator unit 47, Furthermore, the alternator charging unit with the ability to utilize D.C. output which also has multiple levels of results that allows setting in flight the voltage ranges from low as 12 volts on small craft to 48 volts on larger aircraft, and for a system that requires an A.C. voltage 110 to 240 volts the generator 47 can supply this particular type of output voltage also, showing in FIG. 7 is an inverter 25 for changing the voltage from D.C. to A.C. a charging unit 55 for charging the battery 45 that is located in the storage area and sending electrical power out to the propeller motor 707 of the aircraft and supplying to the controls and instruments, a controller 19 for controlling the power to the aircraft propeller motor 707, In figure xx in FIG. 7 is a diagram of a swirl cage wheel unit with all of its components listed out, starting with swirl cage wheel 23 unit that is inside the housing 52 of the of swirl cage wheel; the swirl cage wheel itself has a ring of 612 within the center of the cell to prevent air from passing thru the blades of the cage wheel 23 unit, A.C. alternator 48, DC generator 47, intake 77, a damper 66 unit for adjusting airflow to the swirl cage wheel, small stepper motor 67 for controlling damper airflow unit, air exit 100, bearing block 76, stepper motor 75 opening open for exhausting air.

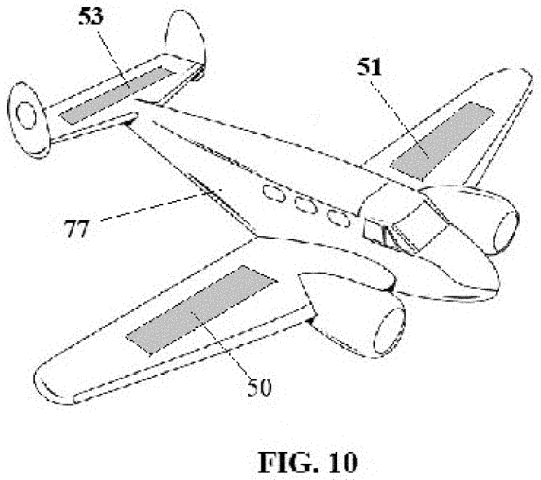

FIG. 10 FIG. 10 shows an illustration of an aircraft with three different locations for a charging unit on an aircraft wing, where a generator unit can install on the aircraft 77 in three different sections of the wings left-wing 10 section 51 on the right-wing 10 section 50 and on the tail 53 section of the plane, this illustration shows how an aircraft can install a generate units in three different locations or install them in all three areas. if the tail 53 the section has two sections. There could be a generator unit in each section on either side of the tail section of the aircraft tail, plus the regenerating braking unit adds more electricity to the aircraft 77 as well.

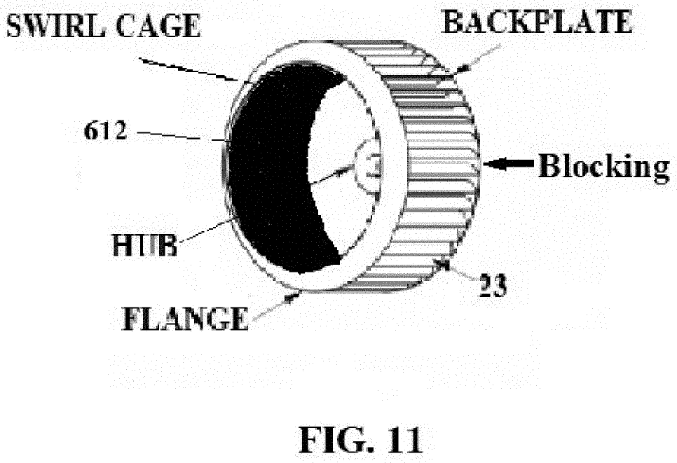

FIG. 11 The kinetic air energy powering from the surface of wing 10 to the swirl cage wheel blades, the swill cage wheel blades have an outer curved section on each fin that capture the kinetic air that pushes against each fin as the air passes over the surface of the aircraft wing turning once the air passes over the wing and turning the driveshaft and the generator unit, the inner housing 52 of the swirl cage wheel unit has an inner sleeve that covers and blocks the passage of air from with the inner lining 612 that is placed within of the swirl cage wheel blades unit within the cavity that blocks the air from passing thru the opening of the blades to give the blades more thrust and torque, this void of air is governed by a damper unit 66 to open in, close, or restrict the amount of airflow that's flowing into the air scoop of the atmosphere of the unit, this non-passing thru the air regular the swirl cage wheel blades/Alternators to aid the electrical system and a small stepper motor 67. Once the blades are spun up to speed, the unit starts producing electrical energy from the alternator unit, the power is withdrawn from the wing 10 swirl cage wheel/Alternators unit, FIG. 10 also has items on the swirl cage wheel. such as the Backplate, hub, Flange, and the inner Hocking shield 612 linings that are shaded in on the drawing.

A inverter 25 converter the electrical energy and makes it available to draw electric power from the Lithium-ion batteries storage bank throughout the aircraft 77, from the bus the primary line of the electrical grid that supplies the electricity for the aircraft 77.

According to one aspect of the present invention there is provided a constant speed from the swirl cage wheel for powering a generator 47 (not an alternator) at a continuous output speed comprising: the alternator and the generator 47 both create electrical energy, and both use the the same process to make this electrical energy, and they both need airflow from the swirl cage wheel blades 23 to rotate to the driveshaft. The only difference is that generator 47 has to run around 3600 rpm to have an output voltage of 120/240 volts at 50/60 Hz this voltage that is regulator by the fin adjustment controller 19 controls the output voltage by adjusting the swirl cage wheel blades 23 up or down above the surface of the wing, 10 or below the surface; and at least one or more swirl cage wheels units that are in line with each other in the exact location or indifferent locations.

Overspeed control system on the swirl cage wheel/alternator shaft is a unique configuration to allow the system to function in an automatic mode whereby the swirl cage wheel blades 23 are lifted up above the surface of the aircraft 77 to increase RPM resolution, the higher the blades are lifted the higher the RPM, the higher the torque when the swirl cage wheel blades 23 are above the surface of the aircraft 77 wing 10, the speed of the blades increases because the blades are catching more Kinetic air energy causes them to rotate a lot faster. The powering of the wing 10s swirl cage wheel/Alternators to aid the propeller motor. Once the blades are spun up to speed and starting powering the alternators, then power is withdrawn so that the wings swirl cage wheel/Alternators are ready to begin operating in when the aircraft reaches an airspeed of thirty, the charging unit start creating electric

The output controller 19 controls send an input signal from the speed controller 19 to the stepper motor to move up when the speed is too low and to move down when the rate is too high, as the kinetic energy that is created by the generator 47 unit and is adjusted by a stepper motor controller 19 with a screw 747 adjustment for controlling the height of the swirl cage wheel blades 23. The alternator unit, alternator unit is maintained in the same manner with the stepper motor and adjustment screw unit raise and lower the swirl cage wheel blades 23 to control the rate of airspeed against the blades, the speed is the air force that is pushing against the blades when aircraft 77 flies into a headwind, the torque increases; therefore, the blades need to adjust the torque demand; this also increases the amount of power output that needed to charge the Lithium-ion batteries, this power is regulated by the voltage regulator that controls the voltages from the generator 47 unit to the Lithium-ion batteries,

The braking unit this unit use the same control process of controlling the voltage that is generated by the regenerative braking unit when the unit applies braking pressure to the braking disk unit, when the braking disk unit is engaging, the shaft drive will also slow down or stop the charging process; this action only occurs when the alternator exceeds a set voltage output limit. The induction of the regeneration braking 90 unit is employed to provide a power control for the swirl cage wheel/alternator system of the aircraft 77 that has wing swirl cage wheel blades 23 for capturing the air.

This is accomplished by using the stored kinetic air energy created by the wing alternator supplies the energy required to power some of the aircraft 77 propeller motor 707 power function augmentation to the aircraft 77 power system with this wing alternator unit. The aircraft 77 alternator with the capturing wing kinetic air energy capture and stores the energy.

As an additional benefit, for electric aircraft 77 without a wing alternator system as employing in the present invention, some of the Lithium-ion batteries could he eliminated from the aircraft 77 by using this powering system to reduce the weight of the aircraft 77, the wing alternator eliminating some of the associated operational costs, weight, and its maintenance costs plus, the cost of fuel while extending the operating range and economy of the aircraft 77 with wing alternator.

The embodiments of the invention disclosed herein employ multiple swirl cage wheel/Alternator unit's configuration integrated onto a driveshaft that rotates within the body of the aircraft 77 wing, creating very little extra weight but is highly efficient and reliable, and cost-effective with its design.

As previously described, the swirl cage wheel/alternator operates with the amount of energy needed to the blades at the speed of the aircraft 77, for example, taxi and takeoff air power assist. Driveshaft 16 and swirl cage wheel are shown in FIG. 8 provide connection of two or more alternators unit together with when only a dual swirl cage wheel.

Overspeed control system on the swirl cage wheel/alternator shaft is a unique configuration to allow the system to function in an automatic mode whereby the swirl cage wheel blades 23 are lifted up above the surface of the aircraft 77 to increase RPM resolution, the higher the blades are lifted the higher the RPM, the higher the torque when the swirl cage wheel blades 23 are above the surface of the aircraft 77 wing, the speed of the blades increases because the blades are catching more Kinetic air energy causes them to rotate a lot faster.

All swirl cage wheel/alternators are sequenced and power balanced with a standard interactive Controller 19. As shown in FIGS. 4 and 10, the swirl cage wheel blades 23 and alternator units on each wing of the aircraft and controlled by one or more controllers 19. The kinetic air energy from the swirl cage wheel/Alternators in charging mode are fed through the same induction regeneration braking 90 line 12 to the batteries bank element as previously described or a portion directed to the onboard storage Lithium-ion batteries 45.

This onboard stored electric kinetic energy is available for use to augment the high demand required for starting motion the aircraft 77 for takeoff, the kinetic air energy demand starts as the airplane power distribution system supplies power to the propeller motor, as the an airplane moves down the runway; the swirl cage wheel unit starts sending electrical energy to the Auxiliary Power Unit (APU) 74 supplies electrical power through airplane electrical power distribution system to through a power converter such as a transformer rectifier unit 62 for transmission from the swirl cage wheel/alternator units.

This system provides an additional layer of energy from the blowing wind on the aircraft 77 while sitting on the tarmac, the system will charge; if it is not fully charging, it will automatically start charging when this occurs if the battery power is low, charging at a low airspeed without the aircraft 77 moving and any input from the cockpit crew.

The locking of the charging unit is employed on embodiments to the charging unit from overcharging of the invention to enhance the charging safety and performance further. It is also a system that lends itself easily to the regulation of charging force applied at each wing which further enhances safety on slick runway conditions.

Once the wing 10 alternators are operating and collecting the kinetic air energy, that's being converted by the charging system for distribution as electric current into the aircraft 77 with induction from the power alternator from the battery's storage bank 45.

The charging 55 system for a passenger aircraft 77 with wing 10 charging unit upon the wing 10 is accomplished by two primary systems processes electrical-mechanical and friction braking. This invention pertains only to a new concept in wing 10s charging 55 with kinetic air energy, since older aircraft 77 with alternator connected to the engine could be retrofitted with the primary functional elements of this new system and an electric propeller motor 707 benefit for fuel-saving, the application space for this invention is potentially all passenger aircraft 77 to have wing 10 power alternator system in the future fleets of new aircraft 77 with wing 10 charging alternator, the aircraft 77 with wing 10 alternators weighs less when transferred too the swirl cage wheel charging system for the charging.

The present invention reduces the operation cost of an aircraft 77 with a wing of 10 alternator unit, while raising the end value of an aircraft 77 with the unit to create enhanced operating margins for both the aircraft 77 with this type of unit, and producer of propeller motor aircraft 77 with wing 10 alternator charging unit. This is accomplished by enabling reduced system weight resultant from reductions in Lithium-ion batteries storage bank 45 mass required for longer flight time, lowering sustaining systems costs from reduced system complexity, reducing system non-recurring costs of simplified production and

procurement requirements, increasing operational range from the weight reduction, decreased charging time, reducing recurring maintenance costs by the use of Lithium-ion batteries storage bank 45 storage area resulting in less charging time.

The invention's production cost and weight reductions are achieved from reductions in the charging 55 time of the Lithium-ion batteries and less overall weight of the Lithium ion batteries storage bank 45. This is achieved by the use of the wing 10 charging 55 plan and the regenerative braking unit,

The kinetic air energy charging 55 from the air is regenerated into the form of electricity and is discharged from the aircraft 77 wing 10 alternator employing induction that's connected to a swirl cage wheel unit that captures the kinetic energy, recovery it, and transmits the electrical energy to the Lithium-ion batteries storage hank 45 storage bank location on the aircraft 77, the with wing 10 alternators are structured to convey the wing alternator electrical power to the lithium-ion batteries storage bank 45 storage location within the aircraft 77 to be used.

The system's ability to capture and use kinetic air energy for powering the aircraft 77 with the wing, the alternator unit provides significant benefits to the environment in the form of reduced air pollution. This reduction is provided by not having to stop for recharging as often of the Lithium-ion batteries.

The air wind charging 55 alternators unit works on a simple principle: when the aircraft moves the air is a force out of the way while the plane is in-flight, the air is moving all over the the surface of the plane, as the air pushes the swirl cage wheel blades 23 turns in FIG. 7 was the dual blades 23 turns the generator unit 47; this kinetic air energy has changed into electrical power. The airflow is being forced into the swirl cage wheel blades 23 that's rotating the swirl cage wheel blades 23 (As shown in FIG. 5) once the high-pressure air pushes on the swirl cage wheel blades, the pressure increases to a higher force that is producing a high speed on the swirl cage wheel blades 23, once this high-pressure air makes contact with the swirl cage wheel blades it begins to turn the shaft that's connected to alternator 48, once the alternator reaches the correct RPM, it will start producing an electrical output to the batteries 45 and electric motor 707.

The kinetic energy describes in the process by which the kinetic energy is used to generate mechanical power to create electricity. This mechanical power can be used to recharge batteries 45 of an aircraft's, or for specific tasks such as electric propeller motor 707, boat, drone, electric motor aircrafts 77 or electric propeller motor 707 aircraft of all models, can used this process to convert kinetic energy into electricity for recharging batteries.

demonstrating the process by using the aerodynamic force from the swirl cage wheel blades, which works the same as an airplane wing 10 or a helicopter rotor fin. In FIG. 10, When the air flows in front of the curved blades as shown in FIG. 10, the air pressure on one side of the blades are decreasing the difference in the air pressure on one side of the swirl cage wheel fin, creating both push inner and pull as it exists because the blades on the swirl cage wheel don't have a block passageway on the swirl cage wheel blades because in there is an inner blocking shield 612 within the inner surface of the swirl cage wheel unit.

The alternator 48 unit has a fixed pitch swirl cage wheel blades 23, and the Alternator 48 swirl cage wheel blades 23 units are directly connected; if the voltage is increased too the alternator, 48 the rpm will increase, and if the voltage decreases, the rpm will decrease and vice-versa. It is not necessary to monitor the rpm on the alternator 48 unit because the two-swirl cage wheel blades unit are connected together; therefore, no Overspeed of the swirl cage wheel. A constant speed swirl cage wheel blades unit has a governor on the swirl cage wheel blades that will automatically adjust for the swirl cage wheel blades to maintain the same rpm and prevent the alternator 48 over the output of voltage while charging 55. A variable pitch swirl cage wheel blades are one where the output voltage is adjusted to a set point, and the controls of the fin angle automatically adjust during flight. This allows for an extensive range in power settings and swirls cage wheel fin speeds to be set, meaning that the most efficient operating point can be selected based on the desired airspeed.

Variable pitch swirl cage wheels can be manually adjusted or mechanically governed to maintain a constant speed irrespective of the flight air condition. Since the swirl cage wheel blades 23 on the alternator 48 is directly linked, the rotation speed of the swirl cage wheel blades 23 is a direct function of the alternator 10 speeds. For this reason, the swirl cage wheel blades 23 rates on the Alternator 48 will vary with airspeed, altitude, aircraft 77 attitude, and alternator throttle setting. The angle that the fin makes with the relative wind will determine how much lift and drag (Thrust and torque) is produced on the alternator 48 swirl cage wheel. The resultant angle of attack is a function of both the rotational velocity of the fin as well as the reverse speed of the Alternator 10 swirl cage wheel blades 23.

The alternator/alternators 20 electric propeller motor 707 energy harnesses from the air 12 is a clean, accessible, and widely available renewable energy source—to generate electric motor 707 power for recharging batteries 45 while using the batteries 45 to operate other components in the aircraft 77 such as light control system etc. . . . , the Output voltage of a generator unit @ 220V, frequency 50/60 Hz, the shaft speed at 3600 rpm at speed is 60 miles an hour, the Alternator 48 charging 55 an electric motor 707 aircraft battery at 11.5 kW an hour, meaning 60-kWh batteries needed about 6 hours to charge the batteries fully. The charger 55 with voltage regulator regulating the voltage, in the inverter 25 also can be used to convert A.C. to three-phase current or to D.C. on a twin system with a dual A.C. unit with a connecting port 277 AC output.

drag into electricity using the aerodynamic force from the swirl blades, when air flows across the fin, the air pressure on one side decreases. The difference in air pressure across the two sides of the fin creates both lift and drag. The force of the lift is stronger than the drag, and this causes the swirl cage wheel to spin. The swirl connects to the Alternator 48, either directly (if it's a direct drive alternator 48) or through a shaft and a series of gears (a gearbox not in the drawing) (FIG. 1 gearbox ) that speed up or slow down the rotation and allow for a physically smaller alternator 48. This translation of aerodynamic force to the process of an alternator 48 creates electricity.

The Alternator 48 in FIG. 7 is small and cylindrical 48 with a bearing the block is 76 for mounting on smaller units like aircraft, mounting bracket for holding the alternator 20 and alternator 48 and the swirl cage wheel, there are many other the position and ways of mounting designs can be used to mount the unit depending on if it's an aircraft, or aircraft.

As stated before, the force of the air is the energy that is needed to make the alternator rotate. Rotation can come from two different sources and power from another swirl cage wheel fin or fan fin. Each additional pressure will eventually create a rotating force on the swirl cage wheel blades 23 alternators 48. In FIG. 4, air 12 is a low-pressure air applied to swirl cage wheel blades and is transformed to a high air 14 pressure force spinning shaft 16 that is attached to the Alternator 48 shafts. The main job of the swirl cage wheel blades is to absorb the energy and apply it to the Alternator 20, and use it to create rotational motion.

as an aircraft 77 moves in the air from its alternator 10, rotating the swirl cage wheel blades 23 and pulls in air 12 and to create thrust; as the swirl cage wheel blades turn to produce thrust, the air 12 is moving at a faster pace applying pressure on swirl cage wheel blades 23 causing the air 14 to have a higher air pressure and more rapid movement to be used to alternator 48 shafts 16, driving the shaft to rotate faster, the rotation of the shaft 16 causes the inner workings of the Alternator 48 to turn more quickly and start producing electricity. The swirl cages wheel blades 23 on the alternator 48 rotates at a lesser speed than the swirl cage wheel blades 23 on the alternator 48 unit.

The current is created due to a law of electromagnetism as the alternator 48 and shaft 16 starts turning to start the induction process in the wire winding inside the alternator housing 52, once the conductor starts creating movement through a magnetic field creates an electric motor 707 and controller 19 current, and that the strength of the current is equal to the rate of change through the magnetic field. So, the faster the copper coil rotates, the more electric motor 707 current will be created.

The electricity that is produced can be extracted from the alternator 48 and sent to the power inverter 25. The controller 19 methods of retrieving the electricity for the propeller motor 707 energies, once the alternator 48 is rotating and creating electric propeller motor 707 power that is created by the movement of the swirl cage wheel blades 23 and sent to the power inverter 25 once the inverter 25 is supplying power to the batteries charger 55, the batteries 45 also supply electric to the propeller motor 707 power from the batteries 45 banks.

Note: in this particular case, the unit creates electric energy from the counterclockwise the direction of the air pushing on the swirl cage wheel blades causing the driveshaft to spin), In FIG. 2 showing the system that is applied to an aircraft wing 10, the layout drawing, and components of an aircraft wing 10, the aircraft wing that can support the invention for connecting the unit on the aircraft wing.

The operation of the swirl cage wheel/alternator can be understood by referring to FIGS. 1, component layout. FIG. 8 showing the system that is applied to an aircraft wing, the layout drawing and components of an aircraft wing 10, the aircraft wing 10 that can support the invention for connecting the unit on the aircraft wing. In FIGS. 4 is an illustration of a generator unit within a wing of an aircraft that's turning a swirl cage wheel unit that is turning a driveshaft creating electrical energy from the air that moving over the aircraft wing and having an opening for the use of air to move around the swirl cage wheel fin 23 using the maximum amount of the power by traveling around the swirl cage wheel cavity and recovering the amount of the mechanism energy and storing this energy into the batteries 45 storage bank.

FIG. 5 as shown the airflow over the wing 10 of the aircraft hitting the swirl cage wheel blades 23, the airflow in thru 717 flows over and around the swirl cage wheel blades causing the rotation of the driveshaft, the passing air then exits 100 thought tunnels 02 thru the body of the wing 10, the process remains the same in both swirl cage wheel units. They are mounted to an adjustable shaft for controlling the amount of air that is received to the blades on the swirl cage wheel unit, the generator is connected on the same drive shaft that is connected, the driveshaft 16 is longer that passes thru swirl cage wheel blades 23 housing 52 in FIG. 4 of the illustration.

The swirl cage wheel blades 23 within a rotation are denoted using the rotation of the connecting drive shaft 16 attached to the alternator 48, and the swirl cage wheel blades 23 by a driveshaft 16. The rotation of the drive shaft 16 provides control of the rotation that's generated by force from the air 4 that was generated from the alternator 48 and swirl cage wheel 23 rotational movements of the driveshaft 16 provide for power extraction to the alternator 48. running at its maximum displacement away from the swirl cage wheel blades 23 and is tilted at an intermediate, the driveshaft 16, as shown in FIG. 4, is at an intermediate displacement away from the swirl cage wheel blades 23 and is tilted at a minimum angle. In this particular embodiment,

In other embodiments, the swirl cage wheel blades can provide adaptation to different weather conditions (with an appropriate fin angle control unit) to provide transformation to different air conditions. In other embodiments, the constraining link may be extendible. In FIG. 7, the drive shaft 16 rotates from the swirl cage wheel blades 23. This allows the alternator to extract power from the rotation of the shaft in a clockwise or counterclockwise rotation. According to the current embodiment, the cycle can be extended for an extended period due to the constant cooling, from the swirl cage wheel blades 23 to the alternator from the air 12 that is being supplied to the alternator outside the cavity, which can extract power from a kinetic energy airflow from left to right. This is particularly useful for removing energy from a moving aircraft 77.

In one application of embodiments of the unit, the regenerative braking unit 30 is for stopping, blocking, or slowing down the alternator swirl cage wheel shaft and keeping the driveshaft from moving when charging 55 system is not needed.

In another application of embodiments of the unit, the alternator unit can recharge batteries 45 even if the aircraft 77 is not being operated, the wind will apply force against the swirl cage wheels of the aircraft, 77 is sitting on the ground in the direction of the wind, the swirl cage wheels blades will start rotating and charging 55 of the aircraft's 77 batteries.

In another application of embodiments of the unit, all gasoline or diesel automobiles, trucks, boats, and aircraft require an alternator for charging 55 batteries 45, which can connected to the engine to create the electric propeller motor energy that is needed for recharging the batteries 45 and maintaining the power within the aircraft 77 as the engine runs, the process require a connection to the batteries 45. of charging 55 multiple types of batteries in addition to the Lithium-ion batteries charging 55 unit is also capable of charging 55 lead-acid batteries like what is in your car, or NiCad batteries for other uses. The control circuitry can adjust the voltage and charge rate, along with the total charge applied to a battery.

In the illustration FIG. 7 shows the process layout on an aircraft wing unit; And their components Alternator charging 55 replenishes part of the voltage back to the batteries while aircraft 77 is in flight; this process helps extend the flight time, sending electrical energy back to the batteries 45 and flying at the same time the system adds some voltage back to your batteries 45 as the aircraft 77 is in flight,

The batteries charging 55 system can often utilize many sources of output power, levels of direct current (D.C.) provided by the alternator 47 unit, Furthermore, the alternator charging 55 unit with the ability to utilize D.C. output which also has multiple levels of outputs that allows charging 55 and flying voltage ranging from low as 12 volts on small craft to 48 volts on lager aircraft, and for a system that requires an A.C. voltage volt, the generator 47 can supply this particular type of output voltage also, shown in FIG. 7, is an inverter 19 for changing the voltage from D.C. to A.C. a charging unit 55 for charging the battery 45 that is located in the storage area and sending electrical power out to the propeller motor of the aircraft and supplying to the controls and instruments, a controller 19 for controlling the power to the aircraft propeller motor 707,

the invention herein involved, the intended that all of the subject matter of the above the description that is shown with the accompanying drawings shall be interpreted merely as a demonstration of the illustrating of the inventive concept herein and shall not be construed as limiting the nature of the invention.

### U.S. Patent Documents

| | | |
|---|---|---|
| 2660443 | November 1953 | Miller |
| 4214160 | July 1980 | Fies et al. |
| 4314160 | February 1982 | Boodman |
| 4476947 | October 1984 | Rynbrandt |
| 5045646 | September 1991 | Musachio |
| 5412293 | May 1995 | Minezawa et al. |
| 5680907 | October 1997 | Weihe |
| 5767663 | June 1998 | Lu |
| 5921334 | July 1999 | Al-Dokhi |
| 6220381 | April 2001 | Damron |
| 6390215 | May 2002 | Kodama |
| 6502842 | January 2003 | Ko |
| 7183746 | February 2007 | Carter |
| 7514803 | April 2009 | Wilks |
| 7547980 | June 2009 | Harrison |
| 7753010 | July 2010 | Rutledge |
| 7913783 | March 2011 | Elmaleh |
| 8063609 | November 2011 | Salasoo |
| 8206263 | June 2012 | Tsuchikawa |
| 8347999 | January 2013 | Koelsch |
| 8712620 | April 2014 | Jackson |
| 8723344 | May 2014 | Dierickx |
| 8872368 | October 2014 | Kim |
| 9321357 | April 2016 | Caldeira |
| 9415660 | August 2016 | Koelsch |
| 9457666 | October 2016 | Caldeira |
| 9981553 | May 2018 | Schafer |
| 10293702 | May 2019 | Tu |
| 10513180 | December 2019 | Quill |
| 10787089 | September 2020 | Macaluso |
| 11007878 | May 2021 | Kamino |
| 2004/0012205 | January 2004 | Sua-An |
| 2005/0224263 | October 2005 | Vasilantone |
| 2006/0238258 | October 2006 | D'Amore |
| 2007/0075677 | April 2007 | Alvarez-Troncoso |
| 2007/0187957 | August 2007 | Harrison |
| 2008/0066979 | March 2008 | Carter |
| 2008/0223637 | September 2008 | Bartilson |
| 2009/0033254 | February 2009 | Nagashima |
| 2009/0079417 | March 2009 | Mort |
| 2010/0019718 | January 2010 | Salasoo |
| 2013/0081886 | April 2013 | Jaberian |
| 2013/0096759 | April 2013 | Breton |
| 2013/0119665 | May 2013 | Berbari |
| 2013/0332014 | December 2013 | Jackson |
| 2014/0285209 | September 2014 | Stichowski et al |
| 2014/0368041 | December 2014 | Tu |
| 2016/0164373 | June 2016 | Liao et al. |
| 2016/0236578 | August 2016 | Liao et al. |
| 2017/0063124 | March 2017 | Yu |
| 2018/0009329 | January 2018 | Tellez |
| 2018/0083469 | March 2018 | Bauer |
| 2018/0215272 | August 2018 | Vitullo et al. |
| 2018/0312159 | November 2018 | Jent, II |
| 2019/0001804 | January 2019 | Wilhide |
| 2019/0004580 | January 2019 | Wilhide |
| 2019/0140245 | May 2019 | Mensch |
| 2019/0351895 | November 2019 | Ben-Ari |
| 2019/0351948 | November 2019 | Derissaint |
| 2020/0384873 | December 2020 | Macaluso |
| 2021/0023954 | January 2021 | Macaluso |

### Foreign Patent Documents

| | | |
|---|---|---|
| WO 2009/149769 | December 2009 | WO |
| WO 2010/133863 | November 2010 | WO |

What is claimed is:

1. An apparatus for charging batteries comprising: a collective body of kinetic air energy that's being creating the movement of the aircraft that start turning the swirl cage wheel fin and alternator unit; creating the electricity from high-pressure kinetic air that's moving the swirl cage wheel blades unit; an alternator unit; an alternator unit; the movement causing the swirl cage wheel blades to start rotating; the high-pressure air coming from the movement of the aircraft forces this volume; the high pressurize air to start the alternator blades rotation; the high-pressure volume of wasted air energy is now being used as an energy source of fuel that's being reused; the alternator swirl cage wheel blades which are rotating and creating the electrical energy from this rotation; an inverter for converting power from D.C. or A.C. and sends the electrical power from the lithium-ion batteries charging unit; the Lithium-ion batteries bank charging is arranged to transform the voltage back to the Lithium-ion batteries and that also supplies power back to the propeller motor and aircraft; a braking unit for changing the RPM ratio of the unit; an inverter to convert D.C. power; energy management unit voltage regular; a swirl cage wheel; stepper motor airflow adjustment unit; a Fixed Pitch blades; a regenerative braking unit; a single or dual alternator unit for supplying A.C. or D.C. output voltage; voltages can be single-phase or three-phase; a self-recharging system for aircraft; automobiles, boats and ships, and trains; an alternator unit can be located anywhere on the plane;

2. The apparatus of claim 1 wherein the kinetic air energy push on the swirl cage wheel blades causing movement to the fixed pitch curved, straight or angle blades that are located on the swirl cage wheel.

3. The apparatus of claim 2 when the kinetic air energy pushes on the blades of a swirl cage wheel it creates rotation of the alternator or generator shaft.

4. The apparatus of claim 3 A kinetic energy transfer system as defined in claim 2 further comprising an induction connection to the energy batteries bank for supplying energy to the aircraft through the regenerative braking unit.

5. The apparatus of claim 4 A kinetic energy system as defined in claim 1 wherein the energy the storage system includes an inverter; converter power; energy management unit to draw excess power from the storage system for distribution through the aircraft.

6. The apparatus of claim 5 operating the swirl cage wheel alternator create energy while in flight and then transferring the energy from the alternator to the battery's storage and redistribution system.

7. The apparatus of claim 6 wherein the alternators' units can be connected in Series, parallel, or Series parallel for different output voltage and amps, to supply the (APU) Auxiliary Power Unit

8. The apparatus of claim 7 wherein the alternator unit moves up and down for speed adjustment of the swirl cage wheel blades that are connected to a single alternator or multiples alternator's unit mounted on a driveshaft.

9. The apparatus of claim 8 The method for aircraft charging unit operations as defined in claim 1, wherein the operation of the swirl cage wheel/alternator as a charging unit provides a longer batteries life and assistance.

10. The apparatus of claim 9 wherein a power inverter for changing from D.C. or A.C. power an inverter is to convert the type of output voltage from the alternators to the battery charging the unit that is charging the batteries;

11. The apparatus of claim 10 wherein when the swirl cage wheel blades begin to rotate is when they come in contact with the air energy that is created by the movement of the wind or the aircraft to start rotation to the alternator unit.

12. The apparatus of claim 11 wherein the blades control unit is arranged in a manner to control the swirl cage wheel blades, speed, and torque by adjusting the height of the airflow damper while the aircraft is moving or sitting still.

13. The apparatus of claim 12, wherein the secondary charging system consists of at least one regenerative braking unit.

14. The apparatus of claim 13 wherein the driveshaft with the regenerative braking system can control the speed of the blades on the driveshaft or stop it from overrunning.

15. The apparatus of claim 14 wherein the generator/alternator unit comprises a stepper motor control unit to increase or decrease the RPMs of the swirl cage wheel blades. That's connected to the generator with the rotation speed of 3600 rpm for 110 or 240 A/C volts output.

16. The apparatus of claim 15, wherein the aircraft comprises a commercial vehicle or non-a commercial vehicle that travels in the air or on the ground, or in water,

17. The apparatus of claim 16, the swirl cage wheel, has an inner sleeve lining to stop the flow of air from passing thru the opening within the swirl cage wheel blades section.

18. The apparatus of claim 17, the swirl cage wheel unit, may have a damper to adjust the amount of kinetic air energy that is flowing into the swirl cage wheel unit to control the speed of the unit or control the output of the generator unit.

19. The apparatus of claim 18, the swirl cage wheel unit, can be mounted under or on top of an aircraft wing with the blades been straight, curved or angle blades, and with or without an air scoop to catch the kinetic air energy.

20. The apparatus of claim 19 is the swirl cage wheel unit that travels or is mounted for catching kinetic air energy and transforming it into mechanical or electrical energy.

21. The apparatus of claim 20, the swirl cage wheel unit, has a blocking shield within the swirl cage wheel to prevent air from flowing thru the adjustable blades of the swirl cage wheel.

22. The apparatus of claim 21, the swirl cage wheel unit, has a tapper air funnel design to concentrate the airflow to the blades of the swirl cage wheel, and the air should flow a least halfway around the swirl cage wheel or exit straight out the back of the swirl cage wheel housing.

23. The apparatus of claim 22, the swirl cage wheel unit, has a generator that rotates and produces the output of 110 to 240 A/C volts output conversing air energy into single-phase or three-phase electrical power.

24. The apparatus of claim 23 is the swirl cage wheel generator/alternator unit that rotates and produces an electrical output of 110 to 240 A/C volts or output of 12 to 48 D.C. volts that's converting air energy on Semi-trucks, Boats, Trains, automobiles, motorcycles, and scooters and Drone aircraft.
